(19) United States
(12) Patent Application Publication
(10) Pub. No.: US 2004/0134696 A1
(43) Pub. Date: Jul. 15, 2004

(54) Road vehicle with hybrid propulsion or alternatively thermal or electrical propulsion

(75) Inventors: Giuseppe Esposito Corcione, Marigliano (IT); Gianluca Vitale, Guagnano (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 10/728,361

(22) Filed: Dec. 4, 2003

(30) Foreign Application Priority Data
Dec. 4, 2002 (IT) VA2002A000065

(51) Int. Cl. B60K 1/00

(52) U.S. Cl. 180/65.2

(57) ABSTRACT

A hybrid vehicle includes an internal combustion engine, an electrical motor, and a drive wheel associated with the electric motor. The drive wheel has a hub, and an axle extending into the hub. The hybrid vehicle also includes a rechargeable battery, and a power circuit for driving the electric motor by drawing power from the rechargeable battery. An electronic torque management unit controls the internal combustion engine and the electric motor. The electric motor is reversible and includes a ferromagnetic pack mounted on the axle for forming a stator within the hub of the drive wheel, and a rotor is mounted adjacent the stator within the hub of the drive wheel.

### FIELD OF THE INVENTION

The present invention relates to road vehicles with a hybrid or dual propulsion system, i.e., thermal and electrical with deceleration energy recovery.

### BACKGROUND OF THE INVENTION

On matters relating to pollution, European Commissions already impose directives that place restrictive limits on emissions produced by thermal engines, and will very likely impose directives that are even more restrictive in the future. The objective of reducing polluting emissions of road vehicles is pursued through several approaches, such as the use of less polluting fuels, improving the efficiency of thermal engine systems, introducing catalytic mufflers, filtering and/or absorbing mufflers of pollutants and the like.

In consideration of the typical way the vehicles are used in large urban areas, abandonment of thermal propulsion in favor of electrical propulsion is hindered by the fact that the batteries need to be periodically recharged (e.g., daily during night hours) by plugging an on-board battery charger circuit into an electrical outlet. This is especially so for motorcycles and the like which are unsuited to accommodate rechargeable batteries having a large capacity.

For this type of vehicle, a hybrid propulsion system has been proposed as comprising a thermal engine and an electrical motor with a battery. The configuration of the propulsion system for either a mixed or hybrid functioning of the two power systems, or alternatively, for only a thermal engine or an electrical motor, is automatically determined by an electronic power management system.

The automatic control system of the instantaneous torque that is made available at the drive wheel or wheels of the vehicle, processes in addition to the driver's commands a plurality of propulsion and run parameters of the vehicle and of the functioning conditions of the two distinct torque generating systems (thermal engine and electrical motor). The control system automatically decides and establishes the respective contributions by the two torque generating systems in meeting the current requirements of the vehicle. Functioning of the two distinct power sources are thus modulated as far as eventually excluding one or the other of the two.

The result, after a certain time of normal use of the vehicle, is an effective reduction of emissions, appropriate for satisfying stringent antipollution laws. Usually, the power take-off of the kinematic transmission of motion to the drive wheel or wheels of the vehicle is the same for the two distinct torque generators: the thermal engine and the electrical motor. In other words, the torque shaft of the engine and the electrical motor are connected to the same single transmission.

Even though there is a need for reducing the total emissions for a given period of use of a hybrid propulsion vehicle, energy saving remains a crucial parameter of overall efficiency of propulsion. It has been found that it is possible and convenient in such a road vehicle with a hybrid thermal/electrical propulsion system to enhance the energy savings, thus contributing to further lower the emissions of pollutants.

This is done by exploiting the reversibility of the electrical torque generating motor for recovering deceleration energy in the form of a charge current of the battery. Such a recovery of deceleration energy in a vehicle with insurmountable limitations to accommodate batteries having a relatively large capacity increases its autonomy when functioning in a full electrical and/or in a hybrid thermal-electrical mode for generating the required torque.

### SUMMARY OF THE INVENTION

In view of the foregoing background, an object of the present invention is to reduce polluting emissions of road vehicles.

This and other objects, advantages and features in accordance with the present invention are provided by efficiently implementing distinct power take-offs, first from the thermal engine shaft through a common motion transmission kinematic chain of mechanical devices that transmit the motion to one or more drive wheels of the vehicle, and second from the electrical motor shaft that is made to coincide with the axle of a drive wheel by mounting the stator of the electrical motor on the axle of the wheel and the rotor of the electrical motor in the hub of the wheel.

The torque that is exerted by the electrical motor on the wheel axle may be automatically regulated by the electronic control system without requiring any mechanical transmission. The wheel or wheels that are driven by the thermal engine and by the electrical motor may even be the same, but according to a particularly effective embodiment of this invention in a motorcycle, the drive wheel associated with the thermal engine is conventionally the rear wheel of the motorcycle. The wheel driven by the electrical motor, and which is thus associated to a reversible electrical machine, is the front wheel of the motorcycle.

The reversible electrical machine that functions as a torque generating electrical motor directly on the axle of the front wheel of the motorcycle absorbs current from the battery, and generates an electrical current during every deceleration phase of the vehicle by acting as a brake for the rotation of the wheel of the motorcycle. The electrical current that is generated during a deceleration phase, through appropriate electronic power circuitry (battery charger), charges the battery, thus recovering energy that otherwise would be dissipated into heat by the mechanical brakes of the vehicle.

The reversible electrical machine, physically integrated in the front wheel of the motorcycle, may be a brushless motor with permanent magnets or a dynamo. In the case of a brushless reversible electrical machine using permanent magnets to produce the excitation magnetic fields, the ferromagnetic pack of the (rotor) stator may be composed of disks of ferromagnetic lamination with radial slots for defining the grooves that accommodate the phase windings. The disks will be slipped over the axle of the front wheel of the motorcycle and eventually fixed to form a stator pack solidly connected to the wheel axle.

The hub of the front wheel also forms a permanent magnetic rotor structure for the electrical machine. A cylindrical hole is defined in the body of the hub, inside which are placed a desired number of uniformly spaced magnetic poles of alternate polarity.

One way of forming the rotor magnetic poles is to install inside the body of a metal or alloy of high magnetic permeability of the hub, a tubular drum of a permanently magnetizable material which has been magnetized per longitudinal bands to establish the desired number of magnetic poles of alternated polarity. A close fit of the drum inside the cavity or hole of the hub provides for an effective closing of the magnetic circuits in the body of the hub. For example, the permanent magnetic drum may be a cylinder of a cermet of plasto-neodymium obtained by sintering, produced by the Chinese corporation KONIT INT. Co. for example, or of a similar permanently magnetized material. Of course, the inner diameter of the drum permanently magnetized by longitudinal bands will be dimensioned as a function of the external diameter of the ferromagnetic pack of the stator assembled on the wheel axle and of the very narrow air-gap to be established therebetween.

The hub, embodying permanent magnets with cylindrical polar faces or a cylindrical drum permanently magnetized per longitudinal bands, is supported by ball bearing or roller bearings that are co-axial with the axle mounted stator.

The assembly has accurate dimensional tolerances to reduce the air-gap between the outer cylindrical surface of the ferromagnetic pack of the stator and the inner cylindrical surface of the drum of permanently magnetized material per longitudinal bands. Alternatively, cylindrical pole surfaces of distinct permanent magnets may be installed in cavities of the inner cylindrical surface of the hole of the hub.

The axle of the front wheel has either a hole or a longitudinal groove for passing electrical connection wires between the terminals of the phase windings of the reversible electrical machine and respective terminals of the electronic power circuitry. This is for driving the phase windings of the motor while the machine is functioning as an electrical motor, and for charging the battery while electrically braking the vehicle when the reversible machine operates as an electrical power generator.

The power circuitry may automatically switch the terminals to configure them as the output terminals of a control circuit that drives the phase windings of the electrical reversible machine (brushless motor) or as the input terminals of a battery charger circuit, absorbing and converting the electric power generated by the reversible machine for re-charging the battery during deceleration (braking) phases.

Both the thermal engine and the electrical motor (reversible electrical machine) may be controlled in a typical mode by an electronic management system for generating respective torque contributions to the road vehicle. The vehicle may be propelled in a hybrid mode, or alternately, with either a totally thermal or with a totally electrical propulsion.

### BRIEF DESCRIPTION OF THE DRAWINGS

FIG. 1 is a basic diagram of a road vehicle with hybrid propulsion, or alternatively, with thermal or electrical propulsion with deceleration energy recovery according to the present invention.

FIG. 2 is a simplified sectional view of a reversible electrical machine integrated in the front wheel of a motorcycle according to the present invention.

FIG. 3 is a block diagram of the control unit that manages the automatic subdivision of the relative torque contributions generated by the two distinct propulsion systems according to the present invention.

### DETAILED DESCRIPTION OF THE PREFERRED EMBODIMENTS

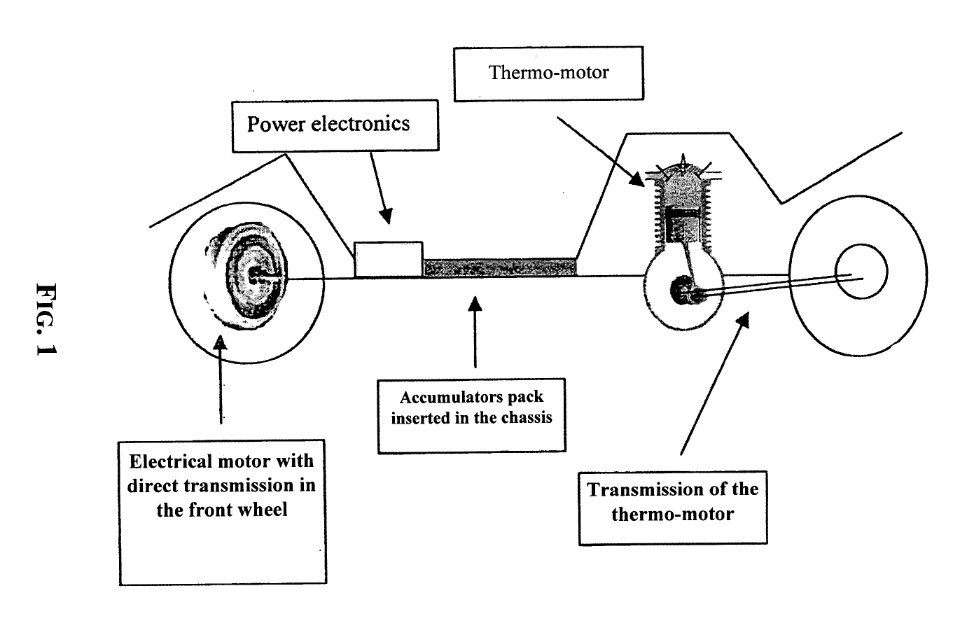

Referring to FIG. 1, the road vehicle, such as a scooter, may, according to the present invention, have a normal thermal engine and transmission connected to the rear wheel. According to the present invention, the vehicle may also be equipped with an electrical propulsion system.

One or more rechargeable batteries provide an appropriate capacity for ensuring a certain functioning of the electrical propulsion system before a recharger may be installed in the chassis of the vehicle, for instance under the platform of the scooter. Also installed on the chassis or body of the vehicle is an electronic control system and the electronic power circuitry for driving the phase windings of an electrical motor and for recharging the battery or batteries.

According to one main aspect of the present invention, the motor of the electrical propulsion system is a reversible electrical machine. The ferromagnetic stator pack of the electrical motor is mounted on the axle of at least one wheel of the vehicle, while the rotor of the electrical motor is installed in the hub of the wheel.

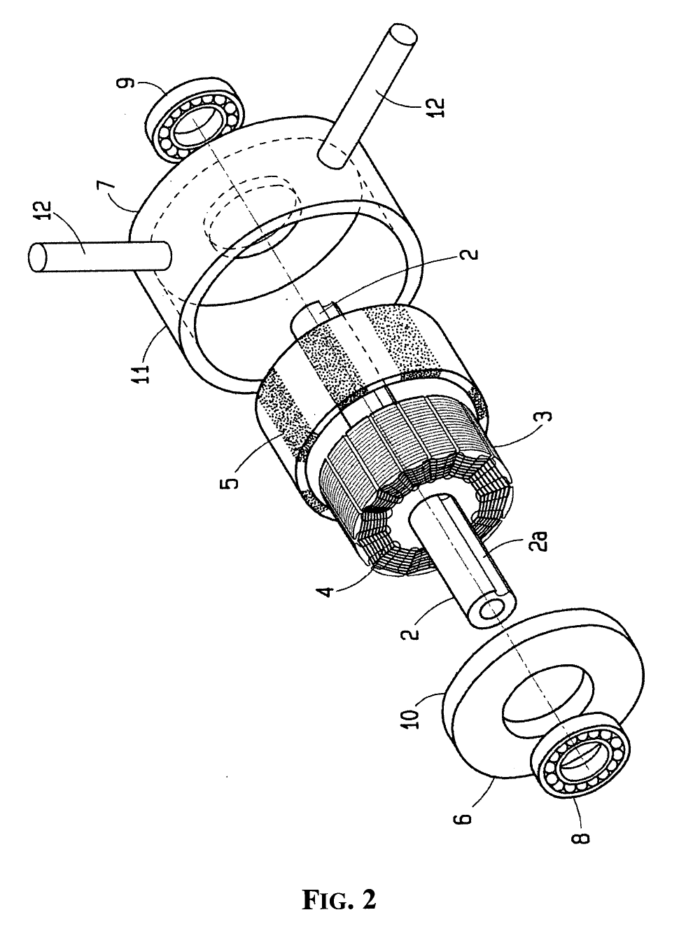

Thus, the electrical motor exerts directly the motor torque on the axle of the wheel without sharing or requiring any transmission. A preferred embodiment of the reversible electrical machine is depicted in FIG. 2. An exploded view of the functional parts of the reversible electrical machine are illustrated.

The axle 2 of the wheel, as in case of a front wheel of a typical motorcycle, is firmly held at the ends of the two legs of the front fork. A ferromagnetic pack 3 is mounted on the axle 2 of the wheel. The ferromagnetic pack 3 forms the stator of the reversible machine. A pack of ferromagnetic laminae 5 is installed inside the hub to form the phase windings of the electrical machine. The phase windings define the magnetic poles of the stator.

The whole stator pack is mechanically fixed to the axle of the wheel 2, which has a groove 2a for accommodating the insulated connecting wires of the phase windings. The insulated conductors of electrical connection of the phase windings to the terminals of the power circuitry may be fastened to one or both legs of the front fork of the motorcycle, and reach the terminals of the motor windings through the groove 2a of the axle of the wheel.

In the illustrated example, the rotor of the electrical reversible machine is composed of a drum 5 functionally defining a plurality of permanent magnets having a radial magnetization. The number of permanent magnets are identical to the number of magnetic poles of the stator, which are fixed inside the hub of the wheel. In the scheme of FIG. 2, this is formed by the two flanges or sides in the form of the half-shells 6 and 7, which are joined together for forming the hub of the wheel, and by the permanent magnet rotor drum 5.

The hub 6, 7 of the wheel, which is connected to the wheel rim, for example by spokes 12, is pivotally supported on the axle 2 of the wheel by two ball bearings 8 and 9 according to normal assembling practices. The axle 2 of the wheel is held at the extremities of the two legs of the front fork of the motorcycle according to a traditional configuration.

The assembling of the relative functional parts depicted in FIG. 2 and the relative mechanical machining are such to ensure the parts are co-axial between the outer cylindrical faces of the stator poles and the inner cylindrical faces of the permanent magnet rotor poles with a minimum air-gap therebetween.

Of course, the permanent magnet rotor drum 5 may be formed in a composite form by using a plurality of permanent magnets having identical dimensions and shape to form a cylindrical drum. The rotor drum may be formed using a cylinder of an appropriate material that is capable of being permanently magnetized per longitudinal bands, for instance, a cylinder of plasto-neodymium formed by sintering or other permanently magnetizable material.

The distinct longitudinal bands of alternately inverted polarity or the permanent magnets are radially magnetized. The external surface of the cylinder of material which is permanently magnetized per longitudinal bands (or of the plurality of magnets arranged and fastened together for forming the cylindrical drum) must be associated with a ferromagnetic casing for eventually closing the magnetic circuits.

The ferromagnetic casing may be either mounted in advance around the magnets or around the sintered drum that is radially magnetized with longitudinal bands having alternately inverted polarities. Also, as depicted in the example of FIG. 2, the ferromagnetic casing may be formed by a cylindrical collar 11 of one of the half-shells that form the hub. The collar 11 accommodates and surrounds the permanent magnetic drum 5 of the rotor of the reversible machine.

The thickness of the collar 11 or of any equivalent ferromagnetic cylindrical casing closing the magnetic circuits should be sufficient for rendering negligible any residual external magnetic field. The drum 5 may be fastened to the collar 11 by glue using an epoxidic or similar structural adhesive, preferably loaded with iron powder for enhancing the magnetic coupling.

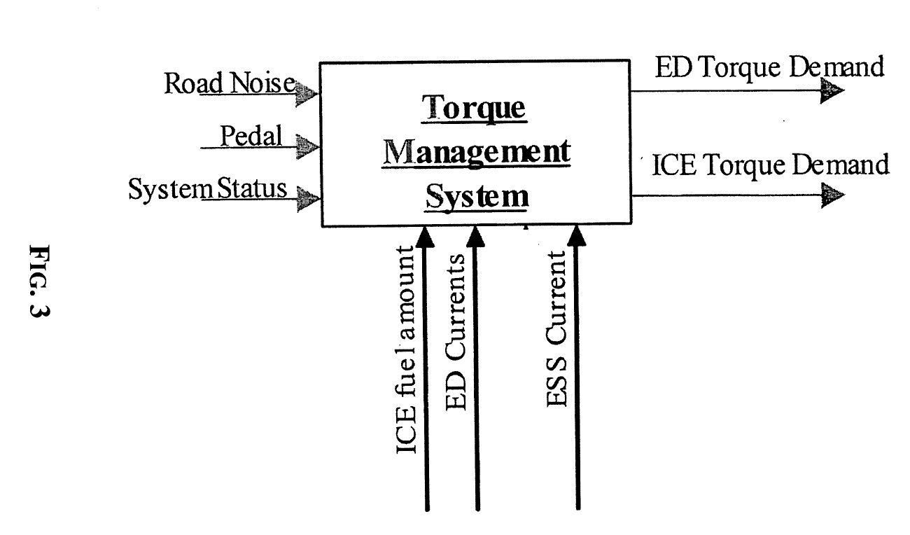

FIG. 3 is a block diagram of the electronic system for managing generation of the required torque. The torque management system (TMS) receives digital signals representing commands directly given by the driver, such as the position of the gas hand grip (accelerator or gas pedal), as well as information on the amount of fuel present in the tank of the vehicle, information on the state of charge of the battery, and information about the type of area being traveled (urban or extra-urban). The latter is either provided by the driver or detected automatically, for instance by a noise analyzer, and optionally, even from other parameters.

By running a resident program, the electronic management system, on the basis of information that is constantly updated, determines in a real time mode the optimal splitting or the generation of the required torque between the two distinct propulsion systems. This is done by modulating their respective loads with respect to excluding one or the other of the propulsion systems. Of course, there may be more than a single resident program to select from according to current needs or preferences by the driver. Selection of the program may be through a dedicated selector.

That which is claimed is:

1. A hybrid or alternatively only thermal or only electrical propulsion, comprising an internal combustion engine, an electrical motor and at least one transmission to one or more drive wheels of the vehicle, al least a rechargeable battery, a power circuitry for driving multiple phase windings of the electrical motor drawing energy from said battery and for recharging said battery, and an electronic torque management unit for controlling the hybrid and/or the exclusive functioning of said engine and said motor for generating the required torque, characterized in that
said electrical motor is a reversible electrical machine, the ferromagnetic pack of which constituting the stator of the machine is mounted on the axle of at least a wheel of the vehicle and the rotor of which is installed inside the hub of the wheel.

2. The vehicle according to claim 1, characterized in that it is a motorcycle and said reversible electrical machine is in the front wheel.

3. The vehicle according to claim 1, characterized in that said reversible electrical machine has a permanent magnet rotor.

4. The vehicle according to claim 3, characterized in that said permanent magnet rotor includes a sintered drum of magnetic material, permanently magnetized per longitudinal bands defining a plurality of magnetic poles of alternate polarity around a circumference.

5. The vehicle according to claim 1, characterized in that terminals of said power circuitry are wired to said phase windings of the machine and said electrical control unit automatically configures said terminals as the output terminals of a phase winding driving circuit and as the input terminals of a battery charger circuit of said power circuitry.
